(19) United States
(12) Patent Application Publication
(10) Pub. No.: US 2009/0019256 A1
(43) Pub. Date: Jan. 15, 2009

(54) Memory transaction handling in a data processing apparatus

(75) Inventors: Katherine Elizabeth Kneebone, Cambridge (GB); David Hennah Mansell, Cambridge (GB)

Correspondence Address: NIXON & VANDERHYE P.C., 901 N. Glebe Road, 11th Floor, Arlington, VA, 22203-1808, US

(73) Assignee: ARM LIMITED

(21) Appl. No.: 12/213,147

(22) Filed: Jun. 16, 2008

(30) Foreign Application Priority Data
Jul. 11, 2007 (GB) 0713462.0

(51) Int. Cl. G06F 12/06

(52) U.S. Cl. 711/209; 711/E12.078

(57) ABSTRACT

A data processing apparatus is provided comprising a memory, memory management unit and identification circuitry for identifying a predetermined type of data access transaction within a plurality of received data access transactions. The memory management unit is responsive to the predetermined type of data access transaction to both permit completion of a data access and to cause an exception to be raised despite completion of the data access having been permitted.

### BACKGROUND OF THE INVENTION

1. Field of the Invention

This invention relates to the field of data processing. More particularly, the invention relates to a memory management unit (MMU) for handling data access transactions in a data processing system.

2. Description of the Prior Art

It is known to use a MMU to mediate read/write access to data stored in a memory. Data access requests are issued by processes running on the data processing apparatus and the MMU processes those requests to determine whether or not access should be granted to the requested memory location by the particular process and to identify the physical location in memory to which the read or write transaction relates. The MMU may not permit access by a given application process to certain regions of memory, for example, if that memory region is reserved for use by the operating system or is otherwise protected or if the memory location has been locked by an exception handling mechanism.

In data processing systems using virtual memory, the MMU typically uses a translation look aside buffer to cache translations of virtual memory addresses (i.e. a logical address used by application programs corresponding to an imaginary storage area) to a physical memory address corresponding to a physical memory location. In known systems the MMU generates an exception, sometimes called an abort, when a data access transaction is received corresponding to a memory location to which access is denied. An abort is also issued in the event of an access request associated with a bad or invalid address. In systems using virtual memory a class of abort exception called a page fault is generated if no mapping from the virtual address to a corresponding physical address can be found in the translation look aside buffer.

In such known systems an exception such as an abort is raised only in the event that the memory access transaction is not allowed to complete by the MMU.

### SUMMARY OF THE INVENTION

Viewed from a first aspect the present invention provides apparatus for processing data, said apparatus comprising:

a memory;

MMU arranged to receive a plurality of data access transactions representing respective data access requests for data stored in said memory, said MMU having:

identification circuitry for identifying a predetermined type of data access transaction within said plurality of data access transactions;

wherein said MMU is responsive to said predetermined type of data access transaction to both (i) permit completion of a data access corresponding to said predetermined type of data access transaction; and (ii) to cause an exception associated with said predetermined type of data access transaction to be raised despite said completion being permitted.

The present invention recognises that it is useful to have a category of data access transactions in which an exception is raised despite completion of the associated data access transaction being permitted by the MMU. Providing an MMU that is responsive in this way to both permit completion of a requested data access and to raise an exception is counter-intuitive in view of known memory management systems which raise an exception only when completion of the requested data access is denied. The predetermined type of data access transaction according to the present technique is advantageous in systems such as “virtualised systems”, in which the physical characteristics of a data processing apparatus are hidden (via an appropriate interface) from program applications or end users that interact with those physical resources.

Although the predetermined type of data access transaction that is identified by the identification circuitry could be any type of data access transaction generated by a processing application or an operating system, in one embodiment the predetermined type of data access transaction is a data access transaction associated with a virtual device being simulated by a data processing apparatus, the virtual device being provided to software (e.g. an operating system) running on the data processing apparatus. In known systems whenever the system requests access to memory address space associated with a virtual device an abort is raised. The instruction causing the abort is decoded and emulated to reflect the intended behaviour of the virtual device. The requirement of software emulation means that there is a large overhead associated with providing virtual devices in virtual systems. However, according to the embodiment in which the predetermined type of data transaction is associated with a virtual device the technique of both raising an exception and permitting completion of the memory access means the instruction that gave rise to the exception need not necessarily be decoded and emulated. Accordingly, computationally intensive software emulation can be avoided in some cases, which reduces the overhead of providing virtual devices in a virtualised system.

It will be appreciated that the data processing apparatus can provide a virtual device to software running on a physical processor (i.e. processor hardware), but in one embodiment the data processing apparatus is configured to provide at least one virtual machine and the software is configured to run on the at least one virtual machine. This enables a plurality of execution environments to exist in parallel and offers improved process isolation. Shared hardware resources can then usefully be modelled as virtual devices and the virtual machine interacts with one or more virtual devices.

Although the virtual device can have any of a number of different functions in the data processing system, in one embodiment the virtual device is arranged to mediate access from the virtual machine to a peripheral device.

It will be appreciated that communication between the virtual machine and the peripheral device can be configured in a variety of different ways, in one embodiment the memory management unit is configured to provide the virtual machine with memory-mapped access to the peripheral device.

The data processing apparatus could provide a single virtual machine. However, in one embodiment the data processing apparatus is configured to provide a plurality of virtual machines and the virtual device is arranged to enable communication between the plurality of virtual machines.

It will be appreciated that the MMU can respond to the predetermined type of data access transaction (identified by the identification circuitry) by permitting completion of the data access substantially simultaneously with causing an exception to be generated associated with that transaction. However, in one embodiment the MMU is arranged to suspend completion of the predetermined type of data access transaction pending return from the exception. This allows the data processing apparatus to prioritise determining whether or not decoding and emulation is required for the associated instruction prior to servicing completion of the memory transaction.

In one embodiment the MMU is arranged to output together with the exception a size of the data access transaction that gave rise to the exception. In cases where a single instruction can transfer a variable amount of data, this allows the exception handler to know what data the instruction is attempting to access and thus avoid having to decode the instruction associated with the exception.

In one embodiment the MMU is arranged to output together with the exception a memory address corresponding to that exception. This enables an exception handler to determine based on the output address whether any action needs to be taken by the data processing apparatus to process the instruction (in addition to completing the data access transaction). In one such embodiment, the memory management unit is arranged to provide an indication of whether the memory address corresponding to the exception is associated with a given one of a read data access and a write data access.

It will be appreciated that an MMU that is responsive to a predetermined type of data access transaction to both permit completion of that transaction and to cause an exception to be raised could be implemented in a data processing apparatus having a Memory Protection Unit (MPU), which does not perform any address translation, but does allow areas of memory to have access permissions and cacheability data associated with those memory areas. However, in one embodiment the MMU comprises address translation circuitry arranged to translate a virtual memory address corresponding to one of the plurality of data access transactions received by the receiving means to a respective physical memory address.

In some of the embodiments that comprise address translation circuitry, the address translation circuitry maintains a page table having at least one page table entry corresponding to the respective virtual memory address. This is an efficient way of implementing address translation since the page table effectively caches address translations.

It will be appreciated that the identification circuitry of the MMU could use any one of a number of different techniques for distinguishing the predetermined type of data access transaction from others of the data access transactions received by the MMU. However, in one embodiment, a page table entry comprises at least one identifier field for distinguishing the predetermined type of data access transaction from other transactions. Provision of an identifier field such as a single-bit identifier enables efficient identification of predetermined data access transactions from the full range of memory transactions yet is straightforward to implement. For example, the single-bit identifier can be used to identify transactions for which it is desirable to cause an exception to be raised despite the transaction being allowed to complete.

In other embodiments rather than using an identifier within the page table entry itself, the identification circuitry comprises a subsidiary access table associated with a page table entry. The subsidiary access table provides an indication of whether a data access transaction corresponding to a virtual memory address is the predetermined type of data access transaction that should give rise to both an exception and completion of the data access. Providing the subsidiary access table allows a finer than page granularity rather than whole page selection in hardware of whether or not a given data access transaction corresponds to a predetermined data access transaction. This provides more flexibility in categorising data access transactions.

In one embodiment having a subsidiary access table, a correspondence between an entry in the subsidiary access table and the page table entry is indicated by a dedicated field within said page table entry. This provides for efficient correlation between page table entries and subsidiary access table entries.

In an alternative embodiment, a correspondence between an entry in the subsidiary access table and the page table entry is derived directly from one of said virtual memory address and said respective physical memory address.

It will be appreciated that in the subsidiary access table any access to a given memory address could be categorised as a predetermined data access transaction such that no distinction is made between a read transaction or a write transaction. However, in some embodiments the subsidiary access table comprises a write-transaction identifier field indicating whether a write transaction associated with a virtual memory address is the predetermined type of data access transaction and a read-transaction indicator field indicating whether a read transaction associated with the virtual memory address is the predetermined type of data access transaction. This enables more fine-tuning in categorisation of data access transactions.

It will be appreciated that in embodiments comprising a subsidiary access table for identifying the predetermined type of data access transaction, which uses both a write-transaction indicator field and read-transaction indicator field, the indicator field could be stored in any one of a number of different ways. However, in one embodiment at least one of the write-transaction identifier fields and at least one of the read-transaction indicator fields are packed into a single entry in the subsidiary access table. This provides for more compact and efficient storage of the transaction-identifying data.

In one embodiment the subsidiary access table comprises a memory array. In other embodiments the subsidiary access table comprises the register bank wherein at least a portion of the subsidiary access table is cached in the register bank. Cacheing of the subsidiary access table in this way reduces the data retrieval time.

According to a second aspect the present invention provides a data processing method comprising the steps of:

receiving a plurality of data access transactions representing respective data access requests for data stored in said memory, said memory management unit having:

identifying a predetermined type of data access transaction within said plurality of data access transactions;

responding to said predetermined type of data access transaction by both

(i) permitting completion of a data access corresponding to said predetermined type of data access transaction; and

(ii) causing an exception associated with said predetermined type of data access transaction to be raised despite said completion being permitted.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 schematically illustrates a data processing apparatus having a memory management unit and identification circuitry;

FIG. 2 schematically illustrates a data processing apparatus implementing platform viralisation and comprising a plurality of virtual machines and virtual devices;

FIG. 3 is a flow chart that schematically illustrates how a virtual device abort can be used to avoid decoding and emulation of a memory access to a virtual device;

FIG. 4A schematically illustrates a page table of a memory management circuit and how virtual device transactions are identified within the page table entries;

FIG. 4B schematically illustrates the use of a subsidiary access table (a virtual device access table) to identify data access transactions of a predetermined type;

FIG. 5 is a flow chart that schematically illustrates a first way in which the MMU of FIG. 1 processes the predetermined type of data access transaction to both perform the memory access and raise an exception;

FIG. 6 is a flow chart that schematically illustrates an alternative way to that of FIG. 5 of processing the predetermined type of data access transaction such that the transaction is completed following return from an exception handler;

FIG. 7 is a flow chart that schematically illustrates processing of a virtual device abort in which decoding and emulation of the instruction associated with the abort is in fact required;

FIG. 8 is a flow chart that schematically illustrates a data access transaction in which a virtual machine attempts to access configuration registers;

FIG. 9 schematically illustrates an interrupt controller having a status register and an enable register;

FIG. 10 schematically illustrates how a data processing apparatus processes a virtual device abort associated with accessing a virtual interrupt controller representing the interrupt controller of FIG. 9;

FIG. 11 is a flow chart that schematically illustrates how a virtual device access table is used to determine whether a given data access transaction should give rise to a virtual device abort.

### DESCRIPTION OF THE PREFERRED EMBODIMENTS

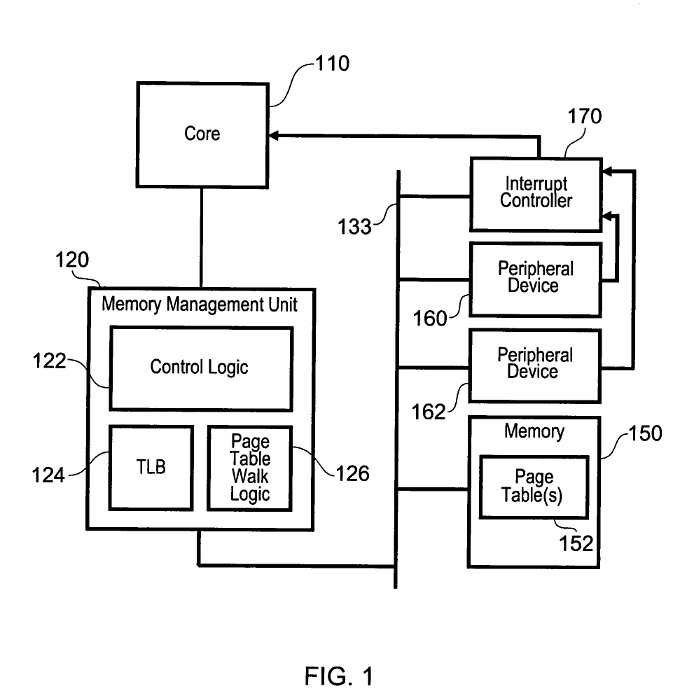

FIG. 1 schematically illustrates a data processing apparatus according to an embodiment of the present invention. The apparatus comprises a core 110; a memory management unit 120 having control logic 122, a Translation Look aside Buffer (TLB) 124 and page table walk logic 126; a memory 150 containing page tables 152; a peripherals 162 and 164; and an interrupt controller 170.

The core 110 executes program instructions in dependence upon control signals. The core 110 is connected to a bus 133 via the memory management unit (MMU) 120, which is arranged to manage memory access requests issued by the core 110. The memory management unit 120 provides access to the bus 133, which connects to memory 150, peripherals 162 and 164, and an interrupt controller 170. The control logic 122 serves to mediate between the core 110 and bus 133 based on information from the page tables 152.

The page table 152 contains a set of translations from virtual addresses into physical addresses. The TLB 124 is a content-addressable memory that is used to translate virtual memory addresses into physical memory addresses and effectively caches virtual to physical address translations. The TLB 124 has a fixed number of entries corresponding to parts of the page table 152. When the core 110 generates a memory access request specifying a virtual address, the TLB 124 within the memory management unit 120 first looks up the address within the translation look aside buffer. If a match for the address is found within the TLB 124 then the physical address corresponding to the specified virtual address is quickly retrieved and is used to access memory. However, if the virtual address does not have a mapping within the TLB 124, then the Page Table Walk Logic 126 looks up the page in the page tables 152 to determine whether an address mapping exists for the specified address. If the mapping does in fact exist in the page table 152 then that mapping is copied into the TLB 124, and the memory access performed. If the virtual address is invalid (e.g. because the page associated with the specified virtual address does not have a mapping, or the code requesting the access does not have the requisite permission to perform it) then the translation will not succeed, and an abort exception will be raised.

The memory management unit 120 uses the page table walk logic 126 to determine whether a given memory access is permissible. Granting of permission for a memory access depends on the identity of the requesting process and the particular memory region to which the requested access relates. For example, an operating system running on the core 110 is allowed to access a full range of memory locations whereas a user application process has restricted read/write permissions such that certain “protected” regions of memory are inaccessible to the process. If the control logic 126 determines that a given memory access is not permitted then it issues an abort signal back to the core 110, which has the effect that the memory transaction does not complete.

The interrupt controller 170 manages servicing of a plurality of interrupts that can be raised by the peripherals 160, 162. The peripherals are hardware resources available to processes running on the core 110 and access to these resources is mediated by the MMU 120.

The control logic 122 is arranged to identify memory access requests from the core 110 corresponding to memory access operations associated with virtual devices. Virtual devices may be managed versions of physical peripheral devices, such as 160, 162 (e.g. they may mediate access to physical peripheral devices) or may exist entirely in software. The memory management unit 120 is responsive to such virtual device memory transactions to both (i) permit completion of the requested read/write transaction; and (ii) generate an exception (such as an abort). By way of contrast, known virtualisation systems forbid completion of read/write accesses to memory locations associated with virtual devices. In such known systems an abort is issued on attempting to perform a virtual device memory access and the aborting memory transaction is emulated in software, this process typically involves decoding the aborting instruction. However, according to the present technique, the memory access is in fact allowed to complete, which means that it is not always necessary to decode and emulate the memory transaction. Although certain categories of virtual device memory access transaction do still require that decoding and emulation be performed.

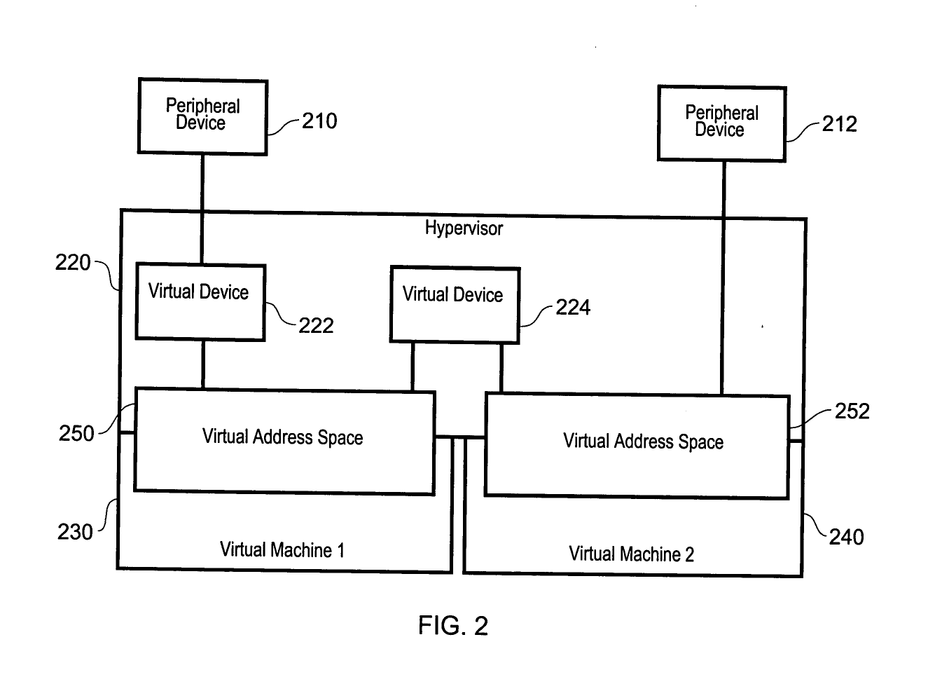

FIG. 2 schematically illustrates a virtualised system. A hypervisor running on a virtualisation-capable machine provides multiple virtual machines. Software running on each virtual machine is provided with the illusion that it is the only software running on the machine. For example, the hypervisor may give several virtual machines the illusion of sole access to a single peripheral device. The system comprises data processing hardware configured to run a hypervisor 220, a first virtual machine 230 and a second virtual machine 240. The first virtual machine 230 has an associated virtual address space 250 and the second virtual machine has an associated virtual address space 252. Note that the virtual machines 230, 240 are not application virtual machines, such as the Java Virtual machine, but instead are platform virtual machines or hardware virtual machines. Platform virtualisation (of which the arrangement of FIG. 2 is an example) involves providing a control program (the hypervisor) on a given hardware platform that creates a simulated computer environment (virtual machine) for guest software (e.g. a complete operating system), which runs as if it were installed on a stand-alone hardware platform.

The hypervisor 220 and the two virtual machines 230, 240 comprise software. The hypervisor provides a plurality of virtual devices 222, 224. Virtual device 222 mediates accesses from the first virtual machine 230 to peripheral device 210. Virtual device 224 exists purely within the hypervisor 220, and can be accessed by both first and second virtual machines 230, 240, perhaps to allow communication between the virtual machines. The second virtual machine 240 is allowed direct access to physical device 212. The hypervisor 220 serves as a virtual machine monitor and allows multiple software systems to simultaneously run on a host hardware platform.

Although the virtual devices 222, 224 are non-physical (i.e. simulated) entities they appear from the perspective of the first virtual machine 230 and the second virtual machine 240 to be memory-mapped (into the respective virtual machine address spaces 250, 252) physical devices. The virtualised system of FIG. 2 makes use of the hypervisor to multiplex access to physical resources such that each one of the virtual machines is provided by the hypervisor with an interface to the physical resources such as peripherals, which hides the fact that the other virtual machine has simultaneous access to those resources.

The hypervisor 220 provides a high degree of isolation and privacy between the virtual machine 230 and the virtual machine 240, relative to sharing of hardware resources performed by an operating system. The hypervisor 220 mediates access permission to memory by each of the virtual machines 230, 240 and also performs the function of abort handling in the event of an abort being issued in response to a requested memory access.

Each of the virtual machines 230, 240 represents a discrete execution environment and each virtual machine 230, 240 in this particular arrangement runs its own operating system (although in alternative arrangements a common operating system is provided). The virtual machines 230, 240 act as execution “sandboxes”, which provide a greater level of isolation between processes relative to running multiple processes alongside each other on the same instance of an operating system. This greater isolation can limit the effects of a single errant process. Also, processes designed for different operating systems can be supported on the same system, by allowing all required operating systems to be run simultaneously.

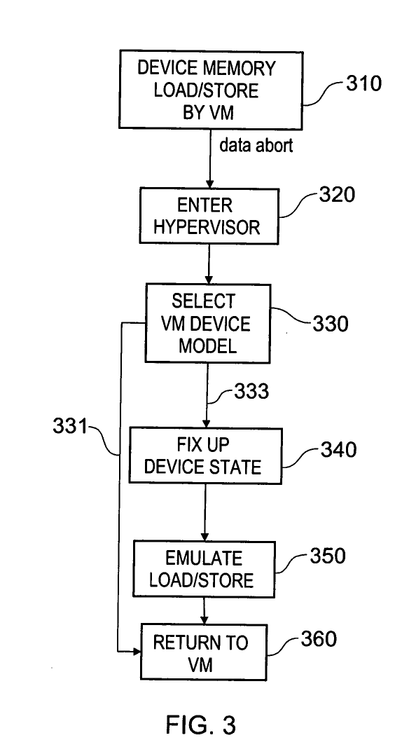

FIG. 3 is a flow chart that schematically illustrates a sequence of events following issuance of a load or store instruction by one of the virtual machines 230, 240 of FIG. 2. The process begins at stage 310 where a given one of the virtual machines 230, 240 issues a load/store request. The control logic 122 of the MMU 120 of FIG. 1 determines from the memory address associated with the load/store request that the load/store transaction is a transaction associated with one of the virtual devices 222, 224. Recall that the virtual devices 222, 224 appear to the virtual machines 230, 240 to be memory mapped devices. Since the load/store transaction is identified as corresponding to a virtual device 222, 224 the MMU control logic 122 allows the transaction to proceed, but also raises an abort to the core 110.

Next, at stage 320, control switches from the virtual machine to the hypervisor 220. This checks the abort address and proceeds to stage 330. The appropriate virtual machine device model (corresponding to one of the two virtual devices 222, 224) associated with the aborted load/store request is selected. Depending upon the attributes associated with the load/store request, the process can proceed in one of two alternative ways. In particular the process will either (i) proceed via path 331 directly to stage 360 whereupon control is transferred from hypervisor back to the virtual machine; (ii) proceed from stage 330 to stage 340 where a “fix-up” of the virtual device state is performed. “Fix up” means at least working out the current state of the virtual device so that the value being read can be constructed, or the value being stored can be acted upon.

If the process follows path 331 (option (i) above) and goes directly from the device model selection stage 330 to pass control from the hypervisor to the virtual machine at 360 then neither decoding of the load/store instruction nor software emulation of the aborted instruction is required. This course of action is appropriate for a subset of load/store instructions depending upon characteristics of the process that issued the load/store transaction.

However, for certain categories of load/store instruction it is in fact necessary to update the state of the appropriate virtual device 222, 224 to reflect that fact that the load/store transaction has been performed. Accordingly, for these transactions path (ii) is followed and at stage 340 the state of the virtual device is updated to reflect the effects of execution of the load/store instruction i.e. a “fix up” of the virtual device is performed. Following on from stage 340, the process proceeds to stage 350 where the load/store instruction is decoded and emulated in software and the state of the given virtual device is appropriately updated. For this second category of load/store transaction control is only passed from the hypervisor back to the virtual machine at stage 360 once the decoding and emulation of the load/store instruction have been performed.

It can be seen from FIG. 3 that whilst for certain load/store instructions decoding and emulation of the instruction is in fact required according to the present technique, there is a subset of load/store instructions for which decoding and emulation of the instruction can be bypassed i.e. for the path 331. Regardless of the fact that decoding and emulation has been bypassed on path 331 of the intended behaviour of the associated virtual device has still been accurately reflected because the hardware permitted completion of the data access transaction prior to passing execution control to the hypervisor at stage 320.

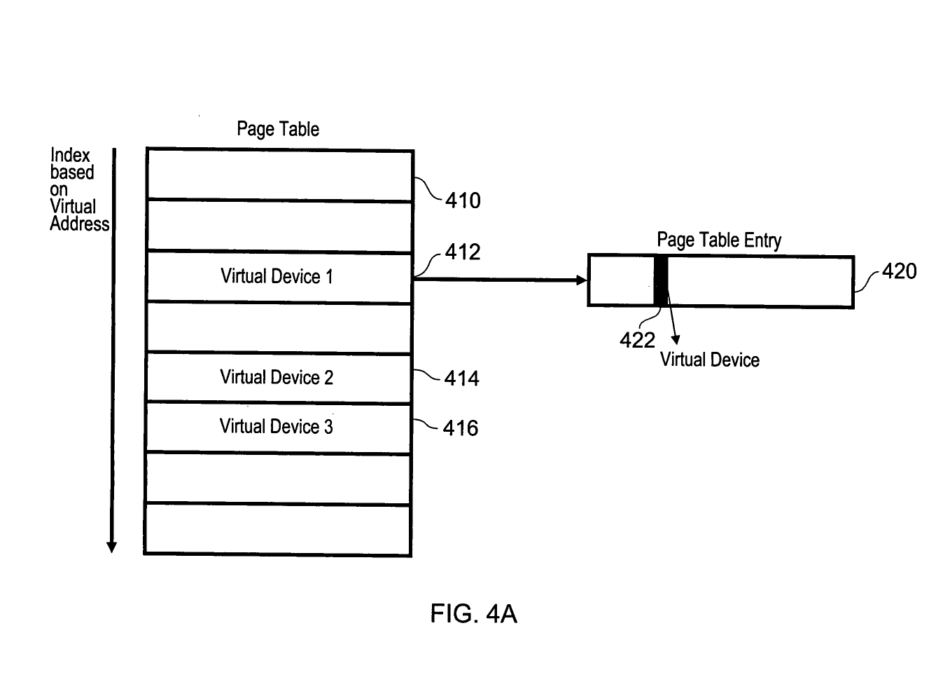

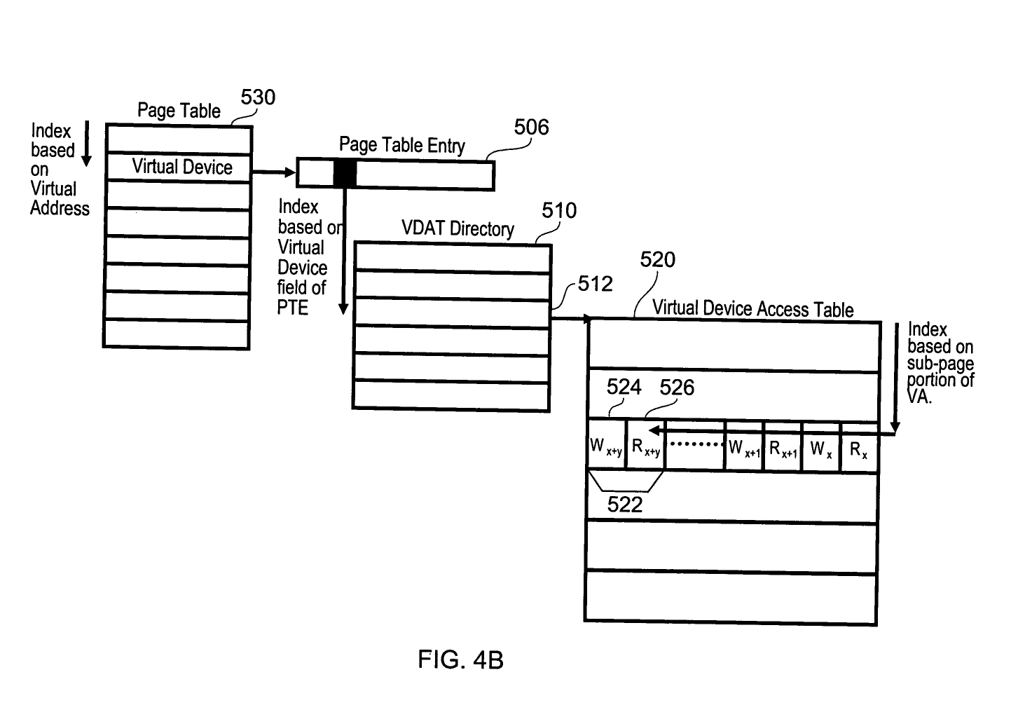

FIG. 4A schematically illustrates a page table configuration that enables the MMU control logic 122 of FIG. 1 to identify memory access transactions associated with one of the virtual devices according to a first embodiment.

The page table 410 is a data structure used to store a mapping between virtual addresses and corresponding physical memory addresses. Virtual addresses are logical addresses that are unique to the accessing process whereas physical addresses are addresses that are unique to the core 110 (i.e. corresponding to locations in the physical memory array). A page is simply a contiguous block of memory. In this embodiment the blocks have a fixed-size but in alternative embodiments there may be several different block sizes. Each page of physical memory is mapped into a correspondingly sized block of virtual memory. Each page table entry comprises mapping information and other information (e.g. access permissions, cacheability) for a given contiguous block of memory.

The page table 410 has a plurality of pages of address space including a page 412 allocated to the first virtual device 222 (see FIG. 2), a page 414 dedicated to the second virtual device 224 and a page 416 dedicated to the third virtual device 226.

Each individual page of the page table 420 contains data 422 indicating if the entry is a page table entry associated with a virtual device. The page table entries enable a received virtual address to be converted into a corresponding physical address for output to the memory system 133 (see FIG. 1). Page table entries associated with one of the virtual devices 222, 224, 226 of FIG. 2 can be to distinguished from other page table entries via a virtual device indicator bit 422 (a single dedicated bit) in the page table entry 420 that is used to indicate whether or not the memory block corresponding to that page is associated with a virtual device. If this virtual device indicator bit=1 then the page table entry corresponds to a memory block that is mapped to a virtual device whereas if the virtual device indicator bit=0 the page table entry is not associated with a virtual device. In alternative embodiments an unused encoding in a field of a pre-existing page table entry is used to indicate that a page table entry belongs to the predetermined type of data access transaction. In some such alternative embodiments page tables have a hierarchical structure and in these embodiments an existing class of page table at a lower hierarchical level is marked as a virtual device at a higher hierarchical level. In yet further alternative embodiments instead of providing dedicated field within said page table entry to indicate a correspondence between an entry in said subsidiary access table and the page table entry, the correspondence is derived directly from one of the virtual memory address and the respective physical memory address associated with the memory transaction.

FIG. 4B schematically illustrates a subsidiary access table (or “virtual device access table”) that can be used by the control logic 122 of FIG. 1 to process memory transactions associated with virtual devices. In the arrangement of FIG. 4B the identification circuitry comprises a page table 530 together with an associated virtual device access table (VDAT) 520. The page table 530 is used to provide a mapping between an incoming virtual address and a physical address that is output to the core 110 (similarly to the page table 410 of the embodiment of FIG. 4A). The page table 530 comprises a plurality of pages, a subset of which are pages corresponding to one of the virtual devices 222, 224 (see FIG. 2). Individual page table entries are typically too small (e.g. one 32-bit word per entry) to contain read/write abort behaviour information for every word in the page. Accordingly, this information is held separately in a VDAT. Each page of memory associated with a virtual device has a VDAT allocated to it. However, note that two or more virtual devices mapped at two separate physical/virtual address pairs can share the same VDAT if the read/write abort behaviour bits are the same for both devices.

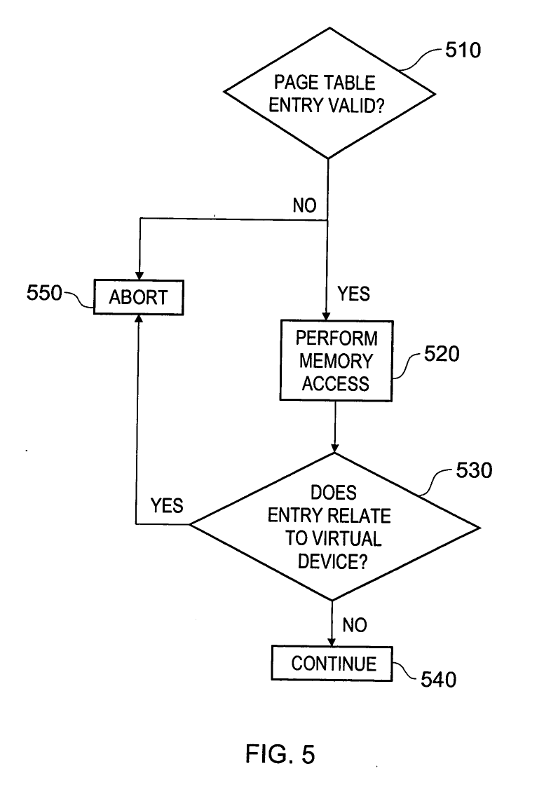

In the page table 530 of FIG. 5, a page table entry 506 is associated with a virtual device. This page table entry in addition to comprising a virtual device indicator bit (as in the example of FIG. 4A), comprises a further field containing an index for an associated VDAT. The VDAT directory 510 contains mappings between the VDAT index numbers and the actual locations of the corresponding VDATs in memory. In the example of FIG. 4B the VDAT index, in the virtual device page table entry is found to correspond to an entry 512 in the VDAT directory and the entry 512 is used to locate the particular corresponding VDAT 520. Once the appropriate VDAT table 520 has been located, the lower bits (sub-page portion) of the memory address that is being translated is used as an index into the VDAT in order to extract the appropriate read/write bits 524, 526.

The individual virtual device access table entry 522 comprises one bit 524 for write accesses and one bit 526 for read accesses. The write access bit 524 indicates whether the write to the corresponding memory word should result in a virtual device abort whereas the read bit 526 indicates whether a read from the corresponding word in memory should give rise to a virtual device abort. A plurality of pairs of read/write bits are packed together within a single data word as shown in FIG. 4B.

In the arrangement of FIG. 4B, the virtual device access table 520 is held entirely in memory, but in alternative arrangements the virtual device access table 520 is stored at least in part by caching within registers.

FIG. 5 is a flow chart that schematically illustrates processing performed by the memory management unit 120 of FIG. 1 in response to a memory access request. The processing begins at stage 550 where the virtual address is used to find a corresponding page table entry and the memory management unit checks whether or not the requested memory access is valid and whether or not it is permitted for the particular requesting process. If at stage 550 it is determined that the page table entry is not valid then the process proceeds directly to stage 558 whereupon an abort is generated and the memory access not completed (i.e. not permitted) by the MMU 120.

Otherwise, if the page table entry is in fact valid then the process proceeds to stage 520 where the memory management unit permits the memory access associated with the request to be performed. The process then proceeds to stage 554 whereupon the control logic 122 of the MMU 120 establishes whether or not the requested access relates to one of the virtual devices 222, 224 (see FIG. 2).

The page table entries (see FIG. 4) are used to identify memory transactions associated with reads or writes to a virtual device. If at stage 554 it is determined that the requested memory access does not relate to virtual device then the process proceeds to stage 556 and processing continues. However, if it is determined at stage 554 that the requested memory access is in fact associated with a virtual device then the process proceeds to stage 558 whereupon the MMU 120 causes an exception (in this case an abort) to be issued. Note that in this case the MMU 120 has both permitted the memory access to be performed and raised an exception.

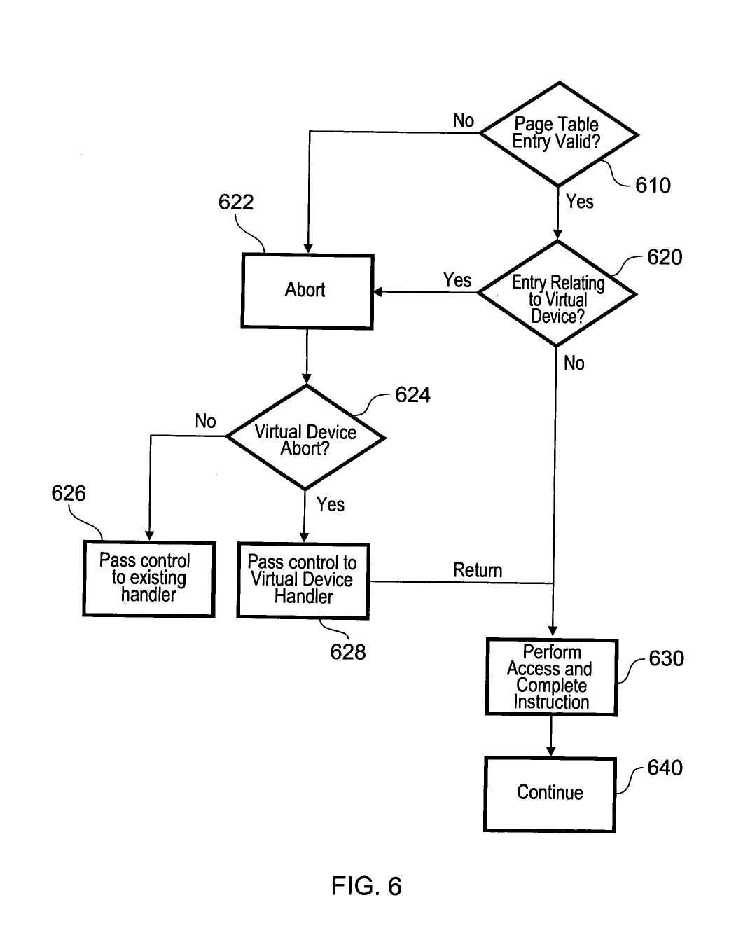

FIG. 6 is a flow chart that schematically illustrates an alternative embodiment to the embodiment of FIG. 5. However whilst the process illustrated by FIG. 5 applies both to read and write accesses, the process illustrated by FIG. 6 applies only to read accesses. In the FIG. 6 arrangement the MMU 120 (see FIG. 1) performs the memory access after having determined whether or not the memory access corresponds to a virtual device. This can be contrasted with the embodiment of FIG. 5 where the memory access is performed (at stage 520) prior to determining (at stage 530) whether or not the memory access is associated with a virtual device.

In the embodiment of FIG. 6 the process starts at stage 610 where the page table entry corresponding to the virtual address is checked for validity and if the address is valid the MMU 120 determines whether or not access to the requested memory region by the requesting process is permitted or not. If access is in fact permitted (and the page table entry is valid) then the process proceeds to stage 620 where the control logic 122 of the MMU 120 determines whether the requested access relates to one of the virtual devices 222, 224 (see FIG. 2).

If the data access transaction is a memory transaction not related to a virtual device then the process proceeds to stage 630 where the memory access is performed by the memory system and the load/store instruction allowed to complete processing then continues at stage 640. However, if at stage 620 it is determined that the requested data access does in fact relate to a virtual device then the process proceeds to stage 622 where an abort is issued to the core 110 (see FIG. 1) and control is passed to the abort handler at stage 624.

In this arrangement the hypervisor 220 (see FIG. 2) performs the function of abort handling and also performs any decoding and emulation required 628 to simulate intended behaviour of the virtual device in response to processes running on the corresponding virtual machine. The abort handler (i.e. the hypervisor 220) determines at stage 624 if the abort was due to a virtual device access. If the abort does in fact correspond to a virtual device access, then the process proceeds to stage 628 where control is passed to the virtual device abort handler of the hypervisor. Otherwise, the process proceeds from stage 624 to stage 626 where control is passed to a standard abort handler.

Once the virtual device abort handler has performed the required processing at stage 628, the process proceeds to stage 630 where the memory access is actually performed, and other side-effects of the instruction requesting the access performed. In this particular arrangement, the need to complete execution of the aborted instruction is signalled to the MMU 120 (see FIG. 1), by a special abort handler return instruction. In alternative arrangements, this is signalled by a configuration bit in a register or by special logic to identify such returns from the hypervisor 220 to a virtual machine 230, 240. Thereafter the process proceeds to stage 640 and processing continues. Similarly to the process illustrated by the flow chart of FIG. 5, if the memory access is valid and associated with a virtual device then the memory access is performed but an abort is also raised in relation to that memory access (path 610, 620, 622, 624, 628, 630, 640).

However, if at stage 610 it is determined that either the access to the specified memory region is not permitted or the page table entry is invalid then the process proceeds directly to issuing an abort at stage 622 and passes control to the standard abort handler at stage 626 where the abort is processed as normal.

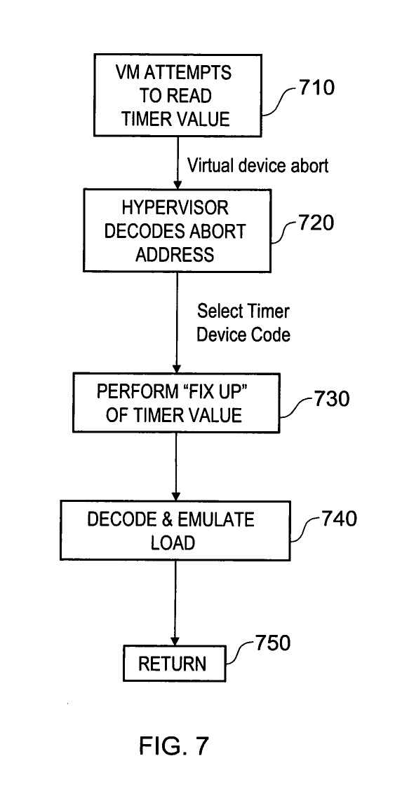

FIG. 7 is a flow chart that schematically illustrates a memory access corresponding to reading a virtual timer (virtual device). The process begins at stage 710 where the virtual machine attempts to read a virtual timer value, which is clearly a dynamic value. The control logic 122 of the MMU (see FIG. 1) identifies the virtual timer read transaction as being associated with a virtual device and accordingly issues a virtual device abort. The process then proceeds to stage 720 where the hypervisor 220 decodes the abort address, identifies the relevant virtual device and selects the virtual device code corresponding to the virtual timer. The hypervisor 220 decides based upon the abort address if any action needs to be taken to fix-up the state of the virtual device to correctly reflect the behaviour of a physical timer to the virtual machine that issued the read transaction. In this case, since the timer value is clearly a time-dependent value it is determined by the hypervisor at stage 730 that a fix-up is in fact required to work out the current state of the virtual device in order to update the timer value. The fix-up is performed so that the time that will be returned by the virtual timer in response to the read transaction will be correct. The process then proceeds to stage 740 where the load instruction associated with the read access is decoded and emulated by the hypervisor. The system then returns control from the hypervisor to the virtual machine at stage 750. The decoding and emulation of the load/store at stage 740 deal involves working out which part of the virtual machine's state (in this embodiment a register) is being stored to/from which part of the virtual device's state. In alternative arrangements memory to memory operations are performed instead of using the register.

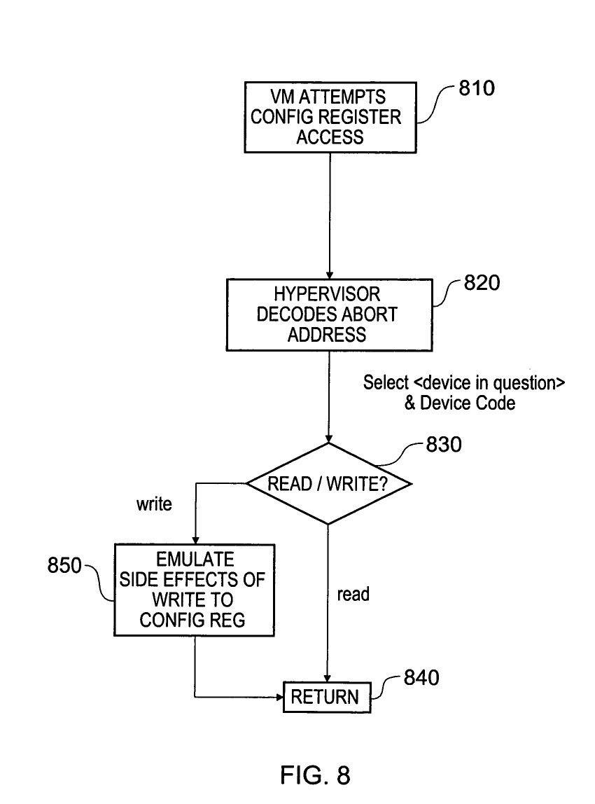

FIG. 8 is a flow chart that schematically illustrates a memory access to a virtual configuration register. In contrast to the virtual timer value of FIG. 7, the value stored by the configuration register is relatively static. The process starts at stage 810 where the virtual machine issues a memory access request relating to a virtual configuration register. The MMU 120 (see FIG. 1) permits completion of the memory transaction but a virtual device abort despite is also raised with regard to the configuration register access. The process then proceeds to stage 820 where control is passed to the hypervisor, which decodes the abort address to determine whether or not a fix-up is necessary. Based on the abort address the hypervisor identifies from the plurality of virtual devices, the particular virtual device to which the memory access relates and then proceeds at stage 830 to determine whether the access corresponds to a read or a write request.

If it is determined at stage 830 that the access corresponds to a read request then the process proceeds to stage 840 where the system immediately returns control to the virtual machine without performing software emulation of the transaction. It is possible to avoid decoding and emulation of the instruction in the event of a configuration register read because the values stored in the configuration registers are typically static.

However, if it is determined at stage 830 that the data access corresponds to a write request then the process proceeds to stage 850 where the state of the virtual device is updated (‘fixed up’) based on the value stored. Following this, the process proceeds to the return stage 840. Thus it can be seen in this case for read requests associated with access to the virtual configuration register software emulation is avoided.

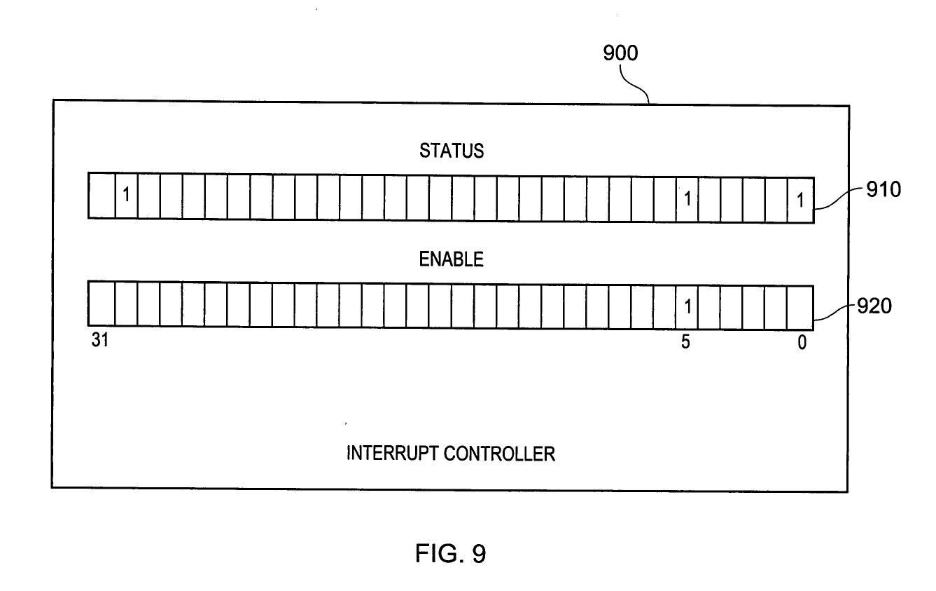

FIG. 9 schematically illustrates the interrupt controller 170 of FIG. 1 in more detail. The interrupt controller 170 has a 32-bit status register 910 and a 32-bit enable register 920. The interrupt controller 170 is operable to manage raising of interrupts to the core 110. Only a single interrupt can be processed by the core 110 at any one time but a plurality of interrupts can be outstanding. Interrupts to a virtual machine 230, 240 (see FIG. 2) can be initiated by any of the peripheral devices 210, 220 or by a virtual device 222, 224.

Read accesses to the status register 910 reads return the status of each of 32 interrupts (one per bit). Writes to the status register allow software triggering of the interrupts such that each bit of the 32-bit register corresponds to a respective software trigger.

In the enable register 920 a value “1” in one of the 32-bit positions indicates that the processor should be interrupted by that interrupt whereas a value of “0” indicates that the corresponding interrupt is currently disabled. Reads of the enable register return the enable bits for each interrupt whereas writes set the state of the enable bits.

In the particular example shown in FIG. 9, three of the bits of the status register have been set to “1” indicating that three different interrupts can potentially be triggered. However, only the enable bit corresponding to bit position 5 has been set. Accordingly, only the interrupt corresponding to bit position 5 is currently activated such that it can be dispatched to the core.

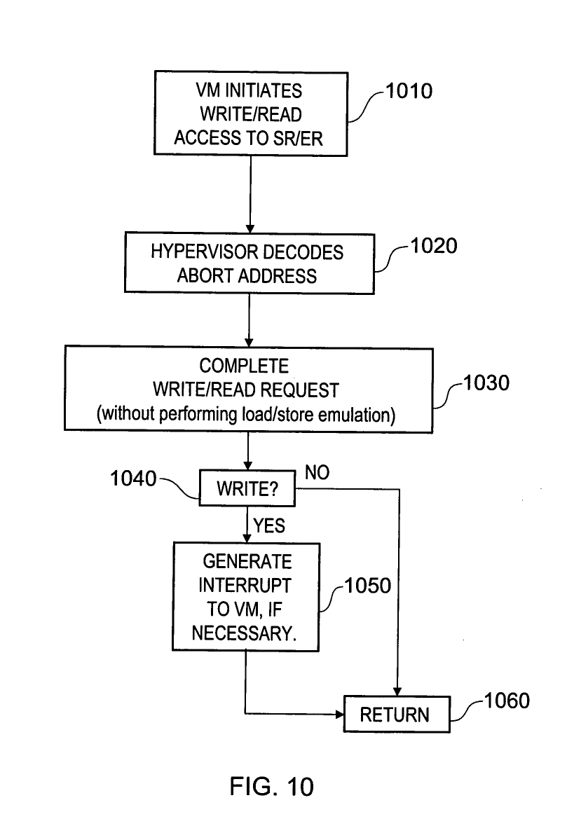

FIG. 10 is a flow chart that schematically illustrates how a virtual interrupt controller corresponding to the physical interrupt controller of FIG. 9 is managed by the hypervisor 220 (see FIG. 2). The process begins at stage 1010 where one of the virtual machines 230, 240 requests a read/write access to the status register or enable register of the interrupt controller. Next, at stage 1020, the hypervisor decodes the abort address to identify that the read/write access is associated with the virtual interrupt controller. The process then proceeds to stage 1030 where the read/write access is performed without performing load/store emulation.

After completion of the read or write request at stage 1030, the process proceeds to stage 1040 where it is determined whether or not the access request relates to a write operation. If the attempted access is a read request rather then the process proceeds directly to stage 1060 and returns.

However, if instead it is determined at stage 1040 that the access request is a write request then the process proceeds to stage 1050 where the hypervisor determines whether or not an interrupt should be generated to one of the virtual machines 230, 240. (An interrupt could be generated because the status bit for an enabled interrupt has been set, or because the enable bit for an interrupt with a set status bit has also been set.) To make this determination the hypervisor 220 establishes from the status register whether an interrupt is active and from the corresponding bit of the enable register whether the interrupt is also enabled. If the interrupt is enabled and active then the interrupt is delivered to the appropriate virtual machine 230, 240 by the hypervisor 220 whereas if the interrupt is not enabled no interrupt will be generated. Since the state of the virtual interrupt controller device (which includes the values stored in the status and enable registers) may be directly manipulated by the virtual machines 230, 240 (when their read/write transactions are allowed to complete before an abort is raised) the hypervisor does not have to perform any decoding or emulation of the aborting accesses.

Note that interrupt status bits may change due to separate hypervisor updates corresponding to changes in the interrupt outputs of other physical or virtual devices, these cases are handled separately.

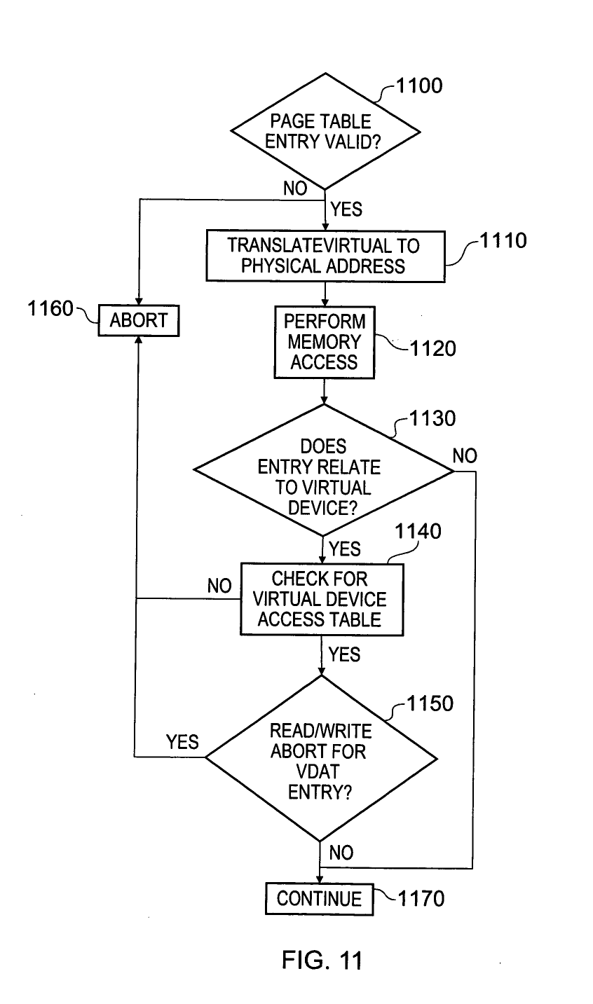

FIG. 11 is a flow chart that schematically illustrates how the MMU 120 of FIG. 1 processes a memory access request in the embodiment of FIG. 4B (which uses a virtual device address table).

At stage 1100 a check is made to check whether or not the associated page table entry is valid and if valid, whether the data access is permissible. If the page table entry is valid then process proceeds to stage 1110 where a virtual to physical address translation is performed and then the memory access is performed by hardware at stage 1120. Once the memory access has been performed it is determined at stage 1130 whether or not the access is related to a virtual device. This determination is made by the identification circuitry 122 of FIG. 1. If it this determined that the access does in fact relate to a virtual device then the process proceeds to stage 1140 where a check is made for a valid Virtual Device Access Table entry field in the Page Table Entry associated with the access.

Next at stage 1150 the entry in the virtual device access table is checked and the individual read or write entry in the virtual device address table is checked to see whether or not a virtual device abort (i.e. an exception) should be raised. If it is decided that no abort should be raised then the process continues to stage 1170. However, if it is decided that an abort should be raised (say for a write operation but not for a read operation) then the process proceeds to stage 1160 where an abort is issued.

In this example embodiment an abort is also issued if it is determined at stage 1100 that the page table entry is not valid or the memory access is not permitted. In this case an abort is raised but the associated memory transaction is not completed. Furthermore an abort is also issued if at stage 1140 it is determined that there is no virtual device access table entry corresponding to the given data access request. In this case the memory access would already have been performed at stage 1120.

Note that in the scheme illustrated by the flow chart of FIG. 11 stages 1110 and 1120 could alternatively be performed in parallel with the virtual device access table look-up so that the memory access is performed contemporaneously with the check for whether the memory access is associated with a virtual device. In steps 1130 and 1140 the existence of a virtual device access table associated with a given page of the page table is used to identify memory access transactions associated with a virtual device instead of using a dedicated bit or dedicated field within a page table entry.

In so far as the embodiments of the invention described above are implemented, at least in part, using software-controlled data processing apparatus, it will be appreciated that a computer program providing such software control and a transmission, storage or other medium which such a computer program is provided are envisaged as aspects of the present invention.

Although illustrative embodiments of the invention have been described in detail herein with reference to the accompanying drawings, it is to be understood that the invention is not limited to those precise embodiments, and that various changes and modifications can be effected therein but one skilled in the art without departing from the scope and spirit of the invention as defied by the appended claims.

We claim:

1. Apparatus for processing data, said apparatus comprising:
a memory;
a memory management unit arranged to receive a plurality of data access transactions representing respective data access requests for data stored in said memory, said memory management unit having:
identification circuitry for identifying a predetermined type of data access transaction within said plurality of data access transactions;
wherein said memory management unit is responsive to said predetermined type of data access transaction to both
(i) permit completion of a data access corresponding to said predetermined type of data access transaction; and
(ii) cause an exception associated with said predetermined type of data access transaction to be raised despite said completion being permitted.

2. Apparatus according to claim 1, wherein said predetermined type of data access transaction is a data access transaction associated with a virtual device being simulated by said data processing apparatus, said virtual device being provided to software running on said data processing apparatus.

3. Apparatus according to claim 2, wherein said data processing apparatus is configured to provide at least one virtual machine and said software is configured to run on said at least one virtual machine.

4. Apparatus according to claim 3, wherein said virtual device is arranged to mediate access from said virtual machine to a peripheral device.

5. Apparatus according to claim 4, wherein said memory management unit is configured to provide said virtual machine with memory-mapped access to said peripheral device.

6. Apparatus according to claim 3, wherein said data processing apparatus is configured to provide a plurality of virtual machines and wherein said virtual device is arranged to enable communication between said plurality of virtual machines.

7. Apparatus according to claim 1, wherein said memory management unit is arranged to suspend completion of said predetermined type of data access transaction pending return from said exception.

8. Apparatus according to claim 1, wherein said memory management unit is arranged to output with said exception a size of said data access transaction that gave rise to said exception.

9. Apparatus according to claim 1, wherein said memory management unit is arranged to output with said exception a memory address corresponding to said exception.

10. Apparatus according to claim 9, wherein said memory management unit is arranged to provide an indication of whether said memory address corresponding to said exception is associated with a given one of a read data access and a write data access.

11. Apparatus according to claim 1, wherein said memory management unit comprises address translation circuitry arranged to translate a virtual memory address corresponding to one of said plurality of data access transactions received by said receiving means to a respective physical memory address.

12. Apparatus according to claim 11, wherein said address translation circuitry maintains a page table having at least one page table entry corresponding to a respective virtual memory address.

13. Apparatus according to claim 12, wherein said page table entry comprises a least one identifier field for distinguishing said predetermined type of data access transaction from others of said plurality of data access transactions received by said receiving means.

14. Apparatus according to claim 13, wherein said at least one identifier field comprises a single bit.

15. Apparatus according to claim 12, wherein said identification circuitry comprises a subsidiary access table associated with said page table entry, said subsidiary access table providing an indication at a finer than page granularity of whether a data access transaction corresponding to said virtual memory address is said predetermined type of data access transaction.

16. Apparatus according to claim 15, wherein a correspondence between an entry in said subsidiary access table and said page table entry is indicated by a dedicated field within said page table entry.

17. Apparatus according to claim 15, wherein a correspondence between an entry in said subsidiary access table and said page table entry is derived directly from one of said virtual memory address and said respective physical memory address.

18. Apparatus according to claim 15, wherein an entry in said subsidiary access table comprises a write-transaction indicator field indicating whether a write transaction associated with said virtual memory address is said predetermined type of data access transaction and a read-transaction indicator field indicating whether a read transaction associated with said virtual memory address is said predetermined type of data access transaction.

19. Apparatus according to claim 18, wherein a plurality comprising at least one of said write-transaction indicator fields and at least one of said read-transaction indicator fields are packed into a single entry in said subsidiary access table.

20. Apparatus according to claim 15, wherein said subsidiary access table comprises a memory array.

21. Apparatus according to claim 15, comprising a register bank wherein at least a portion of said subsidiary access table is cached in said register bank.

22. A data processing method comprising the steps of:
receiving a plurality of data access transactions representing respective data access requests for data stored in said memory, said memory management unit having:
identifying a predetermined type of data access transaction within said plurality of data access transactions;
responding to said predetermined type of data access transaction by both
(i) permitting completion of a data access corresponding to said predetermined type of data access transaction; and
(ii) causing an exception associated with said predetermined type of data access transaction to be raised despite said completion being permitted.
